(19) United States
(12) Patent Application Publication
(10) Pub. No.: US 2009/0183118 A1
(43) Pub. Date: Jul. 16, 2009

(54) METHOD AND APPARATUS FOR DISPLAYING INPUT ELEMENT SELECTION INFORMATION

(75) Inventor: Kil-soo Jung, Osan-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/200,003

(22) Filed: Aug. 28, 2008

(30) Foreign Application Priority Data
Jan. 10, 2008 (KR) 2008-2926

(51) Int. Cl. G06F 3/048

(52) U.S. Cl. 715/817

(57) ABSTRACT

A method of displaying input element selection information on menu information including at least one input element. The method includes receiving a request for an input element selection movement from a currently selected input element to another input element, generating preview information to indicate which input element is to be selected according to the request, and displaying the preview information on the menu information.

### CROSS-REFERENCE TO RELATED APPLICATION

This application claims the benefit of Korean Application No. 2008-2926, filed Jan. 10, 2008 in the Korean Intellectual Property Office, the disclosure of which is incorporated herein by reference.

### BACKGROUND OF THE INVENTION

1. Field of the Invention

Aspects of the present invention relate to a method and apparatus for displaying information used to select input elements, and more particularly, to a method and apparatus for displaying button selection information which makes user's choice of input elements easy by providing in advance information about input elements to be selected by the user before the user selects any input elements.

2. Description of the Related Art

With the development of technology, multimedia having an improved interaction function with users are being widely distributed. The multimedia can provide various additional information desired by the user in addition to AV (audio-video) data. The user can enjoy additional information about a motion picture using interactive data displayed on a screen with the AV data, in addition to the AV data displayed in the motion picture. The user can choose desired information of the various interactive data displayed on the screen by using a user input device such as a remote controller, a mouse, a keyboard, or a touch pad.

FIG. 1 shows a menu screen displaying various interactive information that a user can choose. The user can choose a desired item from a plurality of menus included in an interactive information providing screen 100. Each menu can be displayed as a button, and the user executes a particular menu by choosing a button corresponding to the desired menu using an input device such as a remote controller.

As shown in FIG. 1, when the user inputs a right direction key using an input device in a state in which a predetermined button 101 is selected, it is unclear whether a button of “Francis Lawrence and Aldva Goldsman” 103 in the section “Audio” or a button of “Teaser Trailers” 105 in the section “Trailers” is selected. Accordingly, the user needs to choose a button without knowing which button will be selected so that he/she must choose buttons several times, which takes unnecessary time and effort.

In addition, when an access key is assigned by a content provider to a button indicating each menu, if the provider does not separately indicate the access key, the user is not able to recognize whether the access key exists. Even when the user recognizes the existence of the access key, he/she does not know which access key is mapped to which button so that the user of the access key is not activated. Since the replay screen of a Blu-ray (BD)/HD DVD provides various and complicated interactive menus, the user may be confused when choosing a menu.

### SUMMARY OF THE INVENTION

Aspects of the present invention provide a method and apparatus for displaying input element selection information which can generate information indicating which input element will be selected and provide the generated information to a user when the user requests an input element selection movement so that the user can easily perform a menu selection.

According to an aspect of the present invention, a method is provided to display input element selection information on menu information including at least one input element. The method comprises receiving an input element selection movement request to move from a currently selected input element to another input element, generating preview information indicating which input element is to be selected according to the input element selection movement request, and displaying the preview information on the menu information.

According to another aspect of the present invention, the method further comprises receiving a request for generation of the preview information from a user, wherein the generating of the preview information is performed according to the user's request for generation of the preview information.

According to another aspect of the present invention, the receiving of the input element selection movement request for an input element selection movement comprises receiving a request for one of input elements that are the most adjacent to the currently selected input element in up, down, left, and right directions, respectively, from the currently selected input element as the input element selection movement request.

According to another aspect of the present invention, the generating of the preview information comprises identifying an input element to be selected according to the input element selection movement request, extracting information on a position and size of the identified input element, and generating preview information displaying the identified input element using the extracted position and size information.

According to another aspect of the present invention, the generating of the preview information comprises generating a line connecting the currently selected input element and the identified input element as the preview information; and the displaying of the preview information comprises displaying the generated line on the menu information.

According to another aspect of the present invention, a method is provided to display input element selection information on menu information including at least one input element. The method comprises receiving a request to display access key display information on each input element included in a currently displayed menu information, and displaying the access key display information on each input element corresponding to the request.

According to another aspect of the present invention, the displaying of the access key display information on the input element comprises determining whether access key information for selection of each input element is assigned to each input element included in the currently displayed menu information, generating the access key display information using the assigned access key information when the access key information is assigned to each input element, and displaying the generated access key display information on each input element.

According to another aspect of the present invention, the generating of the access key display information comprises obtaining information on a position and size of each input element to which the access key information is assigned, and generating the access key display information based on the access key information assigned to each input element and the information on the position and size of each input element.

According to another aspect of the present invention, an apparatus is provided to display input element selection information on menu information including at least one input element comprises a user interface to receive an input element selection movement request to move from a currently selected input element to another input element, a preview information generation unit to generate preview information indicating which input element is to be selected according to the input element selection movement request through the user interface, an output unit to display the generated preview information on the menu information, and a controller to control the apparatus to generate the preview information according to the input element selection movement request through the user interface and output the generated preview information.

According to another aspect of the present invention, the user interface receives a preview information generation request and transmits the received request to the controller, and the controller controls the apparatus according to the preview information generation request to generate and output the preview information.

According to another aspect of the present invention, the user interface receives one of input elements that are the most adjacent to the currently selected input element in up, down, left, and right directions, respectively, from the currently selected input element, of the menu information, as the request for an input element selection movement.

According to another aspect of the present invention, the controller identifies an input element to be selected based on the input element selection movement request and informs the preview information generation unit of the identified input element, and the preview information generation unit generates preview information indicating the identified input element based on the information on the position and size of the identified input element.

According to another aspect of the present invention, the preview information generation unit generates a line connecting the currently selected input element and the identified input element as the preview information and the output unit displays the generated line on the menu information.

According to another aspect of the present invention, the user interface is a plurality of user interfaces and includes a dedicated key for input of the preview information.

According to another aspect of the present invention, the user interface supports a two-step pressing function, and when the user interface is half pressed and the controller receives an input element selection movement request, the controller generates preview information, and when the user interface is completely pressed and the input element selection movement is requested, the controller does not generate the preview information.

According to another aspect of the present invention, an apparatus is provided to display input element selection information on menu information including at least one input element. The apparatus comprises a user interface to receive a request for display of access key display information on each input element included in a currently displayed menu information, an access key display information generation unit to generate access key display information for selection of each input element corresponding to the request, an output unit to display the generated access key display information on each input element, and a controller controlling the apparatus to generate the access key display information according to the access key display information display request through the user interface and to output the generated access key display information.

According to another aspect of the present invention, when the access key information for the selection of each input element is assigned to each input element included in the currently displayed menu information, the access key display information generation unit generates the access key display information based on the assigned access key information.

According to another aspect of the present invention, the access key display information generation unit obtains information on the position and size of each input element to which the access key information is assigned and generates the access key display information based on the access key information assigned to each input element and the information on the position and size of each input element.

According to another aspect of the present invention, the user interface is a dedicated key for receiving a request for display of the access key display information.

According to another aspect of the present invention, a computer readable recording medium is provided, which stores a program to execute a method of displaying input element selection information on menu information including at least one input element. The method comprises receiving an input element selection movement request to move from a currently selected input element to another input element, generating preview information to indicate which input element is to be selected according to the request, and displaying the preview information on the menu information.

According to another aspect of the present invention, a computer readable recording medium is provided, which stores a program to execute a method of displaying input element selection information on menu information including at least one input element. The method comprises receiving a request to display access key display information for selection of each input element on each input element included in a currently displayed menu information, and displaying the access key display information corresponding to the request.

According to the present invention, when a user requests an input element selection movement, information indicating which input element will be selected is generated and provided to the user so that the user can easily choose a menu.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become more readily appreciated from the following description of the embodiments, taken in conjunction with the accompanying drawings of which:

FIG. 1 illustrates a menu screen providing various interactive information that a user can select;

FIG. 2 illustrates a button selection information display apparatus according to an embodiment of the present invention;

FIG. 3 illustrates a button selection information display apparatus according to another embodiment of the present invention;

FIGS. 4A-4D illustrate preview information displayed on a menu information (screen) when a method for displaying button selection information according to an embodiment of the present invention is performed;

FIGS. 5A and 5B illustrate access key display information displayed on a screen when a method for displaying button selection information according to another embodiment of the present invention is performed;

FIG. 6 is a flow chart of a process of displaying button selection information according to an embodiment of the present invention;

FIG. 7 is a flow chart of a process of displaying button selection information according to another embodiment of the present invention; and

FIGS. 8A and 8B illustrate a user interface used to request a button selection information display according to an embodiment of the present invention.

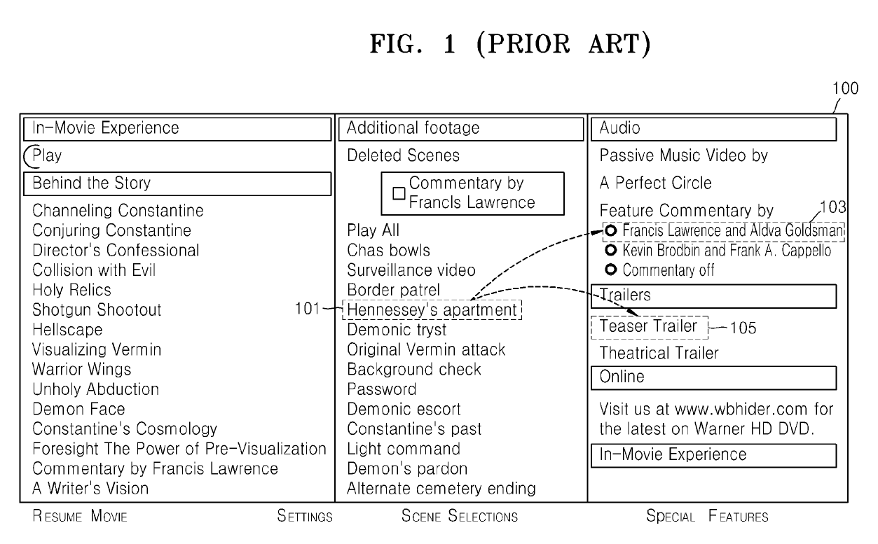

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

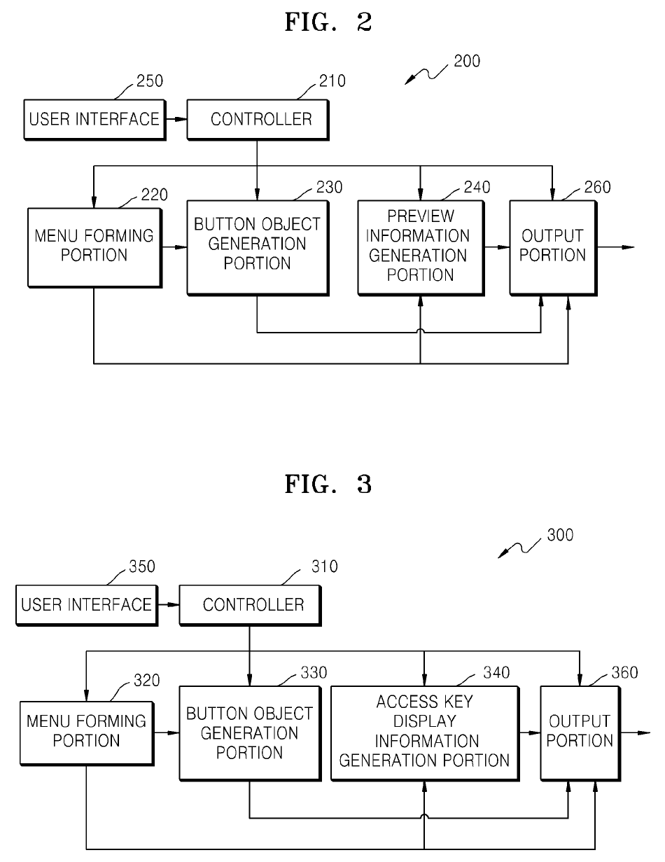

FIG. 2 shows a button selection information display apparatus 200 according to an embodiment of the present invention. The button selection information display apparatus 200 includes a controller 210, a menu forming unit 220, a button object generation unit 230, a preview information generation unit 240, a user interface 250, and an output unit 260. According to other aspects of the present invention, the button selection display apparatus 200 may include additional and/or different units. Similarly, two or more of the above units may be integrated into a single component. The button selection information display apparatus 200 may be a stand-alone device (such as a computer), or incorporated into another device, such as a television, set-top box, home entertainment device, mobile telephone, personal digital assistant, personal entertainment device, a Blu-ray player or recorder, or any device capable of outputting a menu display.

Although not shown in FIG. 2, the button selection information display apparatus 200 may further include an additional information signal de-multiplexer (not shown) that de-multiplexes an additional information signal. The additional information signal de-multiplexer parses a menu related additional information signal of the additional information signal into a menu signal, a button signal, and a preview signal. The additional information signal de-multiplexer transmits the menu signal, the button signal, and the preview signal to the menu forming unit 220, the button object generation unit 230, and the preview information generation unit 240, respectively.

The menu forming unit 220 receives the menu signal from the additional information signal de-multiplexer and generates menu information in which input elements (such as buttons) are laid out, such as a menu screen output through the output unit 260. The input elements may include the buttons; a user can select a desired menu using the button as an input element. The menu signal includes information about a background screen of the menu information and the positions, sizes, and colors of the input elements included in the menu information, information indicating the state of a button (the button included in the menu information is a button selected by the user) selected and commanded to execute, or not selected, and information about the arrangement of the buttons. The menu forming unit 220 generates the menu information about the layout of the buttons by arranging the buttons at predetermined positions based on the menu signal and transmits the generated menu information to the output unit 260. Although described in terms of buttons, the menu may include other interactive elements, such as pull-down boxes, dials, slide controls, and the like.

The button object generation unit 230 receives a button signal from the de-multiplexer. The button signal may include size, color, and image information on each button included in the menu information. The button object generation unit 230 forms buttons listed by being included in the menu information using the button signal. The button object generation unit 230 generates a button having predetermined size and color using the button signal. When the user requests a button selection movement from a currently selected button to a predetermined button through the user interface 250, the controller 210 determines which buttons are adjacent to the currently selected button using the menu information generated by the menu forming unit 220, and recognizes which one of the adjacent buttons must be selected corresponding to the user's request. The controller 210 controls the button object generation unit 230 to generate information indicating that the button is the selected button corresponding to the user's request. The button object generation unit 230 generates information indicating the button is the selected button according to the user's request and transmits the generated information to the output unit 260, under the control of the controller 210. The button object generation unit 230 may indicate that a predetermined button is the selected button by, for example, giving a bold feature to the characters of the corresponding button, enlarging the font size, or changing the color of the button. Other methods may also be employed to identify that the predetermined button is the selected button.

The preview information generation unit 240 receives a preview signal from the de-multiplexer. The preview information generation unit 240 indicates which button is to be selected according to the user's button selection movement request using the preview signal. The preview information is information that is generated to let the user know which button is to be actually selected by the user, when the user requests a button selection movement to select another button from the currently selected button. The preview information generation unit 240 generates preview information when the user requests generation of the preview information through the user interface 250 or a preview information output is set in the button selection information display apparatus 200.

When the user requests generation of the preview information through the user interface 250, or a preview information output is set in the button selection information display apparatus 200 and the user requests a button selection movement, the controller 210 recognizes which buttons are adjacent to the currently selected button and which of the adjacent buttons is to be actually selected according to the user's button selection movement request, based on the menu information generated by the menu forming unit 220. The controller 210 informs the preview information generation unit 240 of the recognized button and controls the preview information generation unit 240 to generate preview information about the recognized button. The preview information generation unit 240 generates the preview information indicating the recognized button, based on the preview signal received from the de-multiplexer and the information on the position and size of the recognized button received from the menu forming unit 220. The preview information generation unit 240 transmits the generated preview information to the output unit 260.

The user interface 250 manages the interface with the user and transmits the user's command to the controller 210. The user interface 250 may include a user input device, such as a keyboard, a mouse, a touch screen, or a microphone. The user interface 250 receives input of a command, characters, numbers, or voice information from the user and transmits the received information to the controller 210. The user requests generation of the preview information or movement of a button from the currently selected button to another button adjacent to the currently selected button, using the user interface 250. When the user interface 250 includes directional keys to select up, down, left, and right movements, the user can request a button selection movement in one of the up, down, left, and right directions from the currently selected button using the directional keys. In some cases, the user interface 250 can be a dedicated key used only for the generation of the preview information, distinguished from other user interfaces that transmit other commands to the controller 210.

The output unit 260 outputs, through a screen or speaker, the general state of the button selection information display apparatus 200 or the information input by the user through the user interface 250. The output unit 260 includes a display (not shown) outputting a video signal and a speaker (not shown) outputting an audio signal. The output unit 260 reconfigures and outputs the menu information by combining the menu information received from the menu forming unit 220 and the button information received from the button object generation unit 230, or by combining the menu information received from the menu forming unit 220 and the preview information received from the preview information generation unit 240.

The controller 210 controls the general operation of the button selection information display apparatus 200 to perform a process of displaying button selection information according to aspects of the present invention. The controller 210 may include an arithmetic logic unit (ALU) performing calculation and a register temporarily storing data and commands. When receiving the user's request to move from the currently selected button to another button through the user interface 250, the controller 210 recognizes which buttons are adjacent to the currently selected button and which one of the adjacent buttons is to be actually selected according to the user's button selection movement request, based on the menu information generated by the menu forming unit 220. Although not required, the controller 210 may be implemented by one or more processors.

When output of the preview information is set in the button selection information display apparatus 200 or the user requested generation of the preview information, the controller 210 informs the preview information generation unit 240 of which button will be selected according to the user's button selection movement request and controls the preview information generation unit 240 to generate preview information for the recognized button. When the output of the preview information is not set in the button selection information display apparatus 200 or there is no request from the user for the generation of the preview information, the controller 210 informs the button object generation unit 230 which button is selected according to the user's button selection movement request and controls the button object generation unit 230 to generate information indicating that the button is newly selected by the user. The button object generation unit 230 generates information indicating that the button informed by the controller 210 is the newly selected button and transmits the information to the output unit 260.

FIG. 3 shows a button selection information display apparatus 300 according to another embodiment of the present invention. The button selection information display apparatus 300 includes a controller 310, a menu forming unit 320, a button object generation unit 330, an access key display information generation unit 340, a user interface 350, and an output unit 360. Since the functions and operations of the other constituent elements of the button selection information display apparatus 300 except for the access key display information generation unit 340 are similar to the corresponding elements included in the button selection information display apparatus 200 of FIG. 2, detailed descriptions thereof will be omitted herein.

The button selection information display apparatus 300 may further include an additional information signal de-multiplexer (not shown) that de-multiplexes an additional information signal. The additional information signal de-multiplexer parses a menu related additional information signal of the additional information signal regarding an AV media signal into a menu signal, a button signal, and an access key signal. The additional information signal de-multiplexer transmits the menu signal, the button signal, and the access key signal to the menu forming unit 320, the button object generation unit 330, and the access key display information generation unit 340, respectively.

The menu forming unit 320 generates menu information to be output through the output unit 360. The access key display information generation unit 340 receives an access key signal from the additional information signal de-multiplexer and generates access key display information according to the user's request of generation of access key display information. The display information intrinsic to a button that a user assigned to each button for easy selection of the button is referred to as the access key display information. The information on the generation of access key display information is included in the menu information is referred to as the access key information. The information on the generation of the access key display information may be assigned to each button by a menu signal encoding apparatus (not shown),

When the user requests generation of the access key display information, the access key display information generation unit 340 determines whether access key information for the selection of each button included in the menu information that is currently displayed is assigned to each button or not. When there is access key information assigned to the button included in the currently displayed menu information, the access key display information generation unit 340 generates access key display information for each button based on access key information and information on the position and size of each button to which the access key information is assigned. The access key display information generation unit 340 transmits the generated access key display information to the output unit 360. The output unit 360 reconfigures and outputs the menu information by combining the menu information received from the menu forming unit 320 and the access key information received from the access key display information generation unit 340.

The user commands the controller 310 to display access key display information for selection of each button included in the currently displayed menu information via the user interface 350. In some cases, the user interface 350 can be a dedicated key to request the access key display information only which is distinguished from user interface that can transmit other commands to the controller 310. Upon a request for display of access key display information received from the user interface 350, the controller 310 controls the access key display information generation unit 340 to generate the access key display information and controls the output unit 360 to output the generated access key display information.

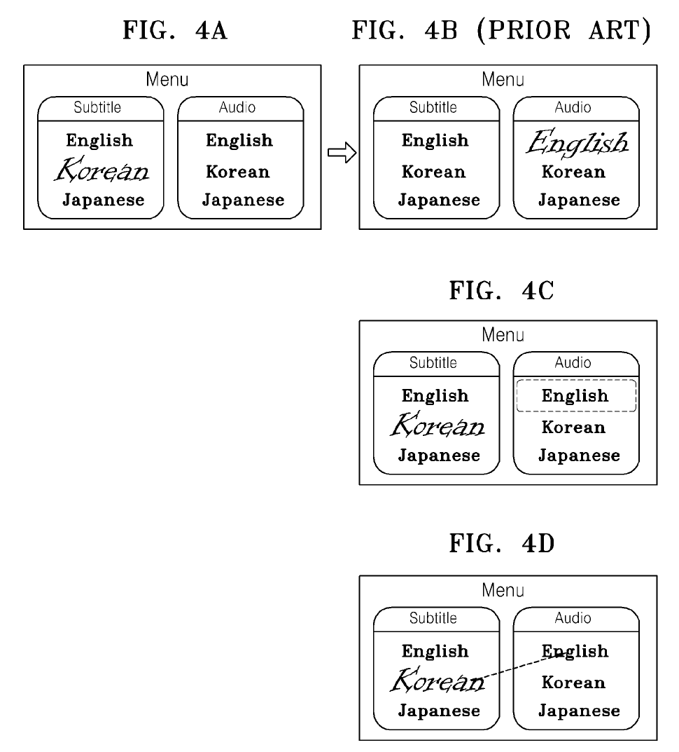

FIGS. 4A-4D show preview information displayed on a menu information (screen) when a process of displaying button selection information according to an embodiment of the present invention is performed. In FIG. 4A, a screen shows a menu information (screen) currently output to the output unit 260. As shown in FIG. 4A, among language information about a subtitle, the word “Korean” is indicated in a larger font than the other words. This indicates that the user selected “Korean” as the language information about the subtitle of the menu information.

FIG. 4B shows a selected button in a conventional method when the user selects information on audio of the menu information and gives a button selection command by inputting a right button. When the user selects the right button of the currently selected button by the user in a right button (such as a direction key,) the controller 210 identifies which buttons are adjacent to the currently selected button, (the Korean language of the subtitle) and which button is located in the right side corresponding to the user's request, based on the menu information generated by the menu forming unit 220, and informs the button object generation unit 230 of a result of the identification. The button object generation unit 230 generates information indicating a newly selected button according to a button input by the user using the information on the position and size of the identified button. The button object generation unit 230 generates a button in which the word “English” is indicated in a larger font than any other buttons in order to indicate that the button newly selected by the user is information about English audio. The output unit 260 reconfigures the menu information by combining the menu information generated by the menu forming unit 220 and the button generated by the button object generation unit 230 and outputs the reconfigured menu information as shown in FIG. 4B.

FIGS. 4C and 4D show the preview information output according to aspects of the present invention. When the user gives a button selection movement command to the right side by inputting the right button using a direction key in FIG. 4A, the controller 210 identifies which buttons are adjacent to the currently selected button, that is, the word “Korean” of the subtitle, and which one of the adjacent buttons is located in the right side corresponding to the user's request, based on the menu information generated by the menu forming unit 220. The controller 210 informs the preview information generation unit 240 of a result of the identification. The preview information generation unit 240 generates preview information about the button to be selected with reference to the information on the position and size of the identified button. In FIG. 4C, the preview information indicates the button to be selected in a dotted line. The screen indicates that the menu information selected by the user is “Korean” in the subtitle and, when the user clicks the right button, the menu selection will be moved to “English” of the audio information.

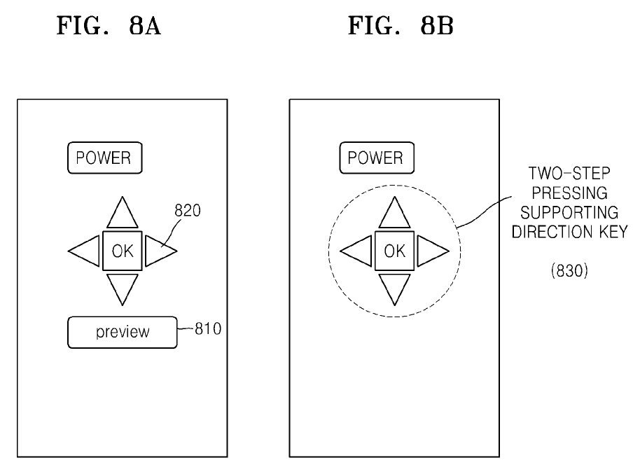

FIG. 4D shows preview information by connecting the currently selected button and the button to be selected using a dotted line. In this case, as in FIG. 4C, the screen shown in FIG. 4D indicates that the menu information selected by the user is “Korean” in the subtitle and, when the user clicks the right button, the menu selection will be moved to “English” audio. Since the user can easily identify which button will be selected using the screens FIG. 4C and 4D, an unnecessary selection can be avoided. After recognizing which button will be selected when the right button is clicked using the preview information, the user can select the right button by clicking the right button again or requesting a button selection movement using another user interface, such as described below in detail with reference to FIG. 8.

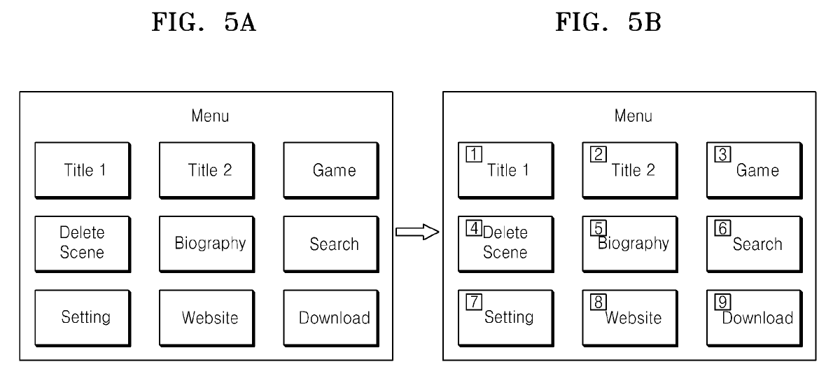

FIGS. 5A and 5B show access key display information displayed on a screen when a method for displaying button selection information according to another embodiment of the present invention is performed. When a screen as shown in FIG. 5A is displayed through the output unit 360, the user can request display of access key display information to the button selection information display apparatus 300 using the user interface 350. Upon the user's request, the access key display information generation unit 340 determines whether access key information for button selection is assigned to each button included in the menu information that is currently displayed. When the access key information is assigned, the access key display information generation unit 340 generates the access key display information using the assigned access key information. The access key display information generation unit 340 checks the information on the position and size of each button to which the access key information is assigned and generates access key display information based on the access key information assigned to each button and the information on the position and size of each button.

The output unit 360 receives the menu information from the menu forming unit 320 and the access display information from the access key display information generation unit 340, reconfigures the menu information by combining the information, and outputs the reconfigured menu information to a screen as shown in FIG. 5B. The user can easily select a desired button using the access key display information assigned to each button in the screen shown in FIG. 5B. For example, when the user selects Title 2, the user inputs #2 key using the user interface 350 so as to be easily select a desired button.

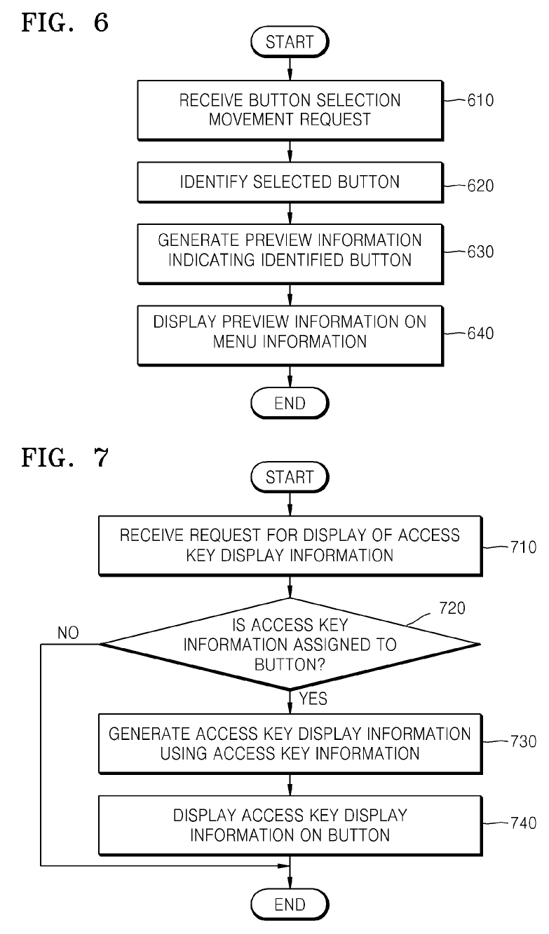

FIG. 6 is a flow chart of a process of displaying button selection information according to an embodiment of the present invention. The user requests a button selection movement through the user interface 250 in operation S610. The controller 210 identifies the button to be selected according to the user's button selection movement in operation S620. To this end, the controller 210 identifies which button is currently selected by the user and which buttons are adjacent to the currently selected button using the menu information generated by the menu forming unit 220 and identifies which button will be selected according to the user's button selection movement request.

When the button selection information display apparatus 200 is set to perform the generation of preview information or there is a request by a user for the generation of preview information, the controller 210 informs the preview information generation unit 240 of the button to be selected and controls the preview information generation unit 240 to generate the preview information. The preview information generation unit 240 generates the preview information indicating which button will be selected in operation S630. The preview information can be a dotted line indicating the button to be selected as described with reference to the screens of FIGS. 4C and 4D. The preview information generation unit 240 transmits the generated preview information to the output unit 260. The output unit 260 reconfigures the menu information by combining the generated preview information and the menu information received from the menu forming unit 220 and outputs the reconfigured menu information in operation S640.

FIG. 7 is a flow chart of a process of displaying button selection information according to another embodiment of the present invention. The controller 310 receives a request for display of the access key display information by the user through the user interface 350 in operation S710. Upon the user's request for the display of the access key display information, the controller 310 determines whether access key information is assigned to each button included in a screen currently output by the output unit 360 in operation S720. When the access key information is assigned to the button, the controller 310 controls the access key display information generation unit 340 to generate the access key display information. The access key display information generation unit 340 generates access key display information based on the access key information in operation S730, and transmits the generated access key display information to the output unit 360. The output unit 360 reconfigures the menu information by combining the menu information received from the menu forming unit 320 and the access key display information received from the access key display information generation unit 340, and outputs the reconfigured menu information in operation S740. Thus, the user can easily select a desired button using the access key display information output from the output unit 360.

FIGS. 8A and 8B show a user interface used to request a button selection information display according to an embodiment of the present invention. As shown in FIG. 8A, a preview button 810 is separately provided for a preview request. In the user interface of FIG. 8A, when the user presses the preview button 810 once, a preview function is activated. When the user presses the preview button 810 again, the preview function is deactivated. If the user presses the preview button 810 once to activate the preview function and the user gives a button selection movement command by inputting a direction key 820, the controller 210 checks which buttons are adjacent to the currently selected button, identifies which one of the adjacent buttons will be selected corresponding to the user's input of the direction key 820, and controls the preview information generation unit 240 to generate preview information on the identified button. Although the user interface of FIG. 8A includes the preview button 810, an access key display information button (not shown) can be provided instead of the preview button 810. In this case, when the user presses the access key display information button, the access key display information generation unit 340 generates access key display information about the button included in the screen output by the output unit 360 and the output unit 360 displays a screen including the access key display information.

In a user interface shown in FIG. 8B, without a separate button for preview request, the preview function can be implemented by supporting a two-step pressing function in a direction key 830. When the direction key 80 is half pressed, the preview function is set and, when the direction key 80 is completely pressed, the preview function is deactivated. When the user presses the direction key 830 in a half way, the preview function is set. Accordingly, the button selection information display apparatus 200 generates and outputs preview information for the adjacent buttons in a direction of a button pressed by the user. When the user completely presses the direction key 830, the preview function is deactivated so that the user can have a button selection movement in a desired direction.

Aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CD-ROMs, magnetic tapes, floppy disks, and optical data storage devices. Aspects of the present invention can also be embodied as carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of displaying input element selection information on menu information including at least one input element, the method comprising:
receiving an input element selection movement request to move from a currently selected input element to another input element;
generating preview information indicating which input element is to be selected according to the input element selection movement request; and
displaying the preview information on the menu information.

2. The method of claim 1, further comprising:
receiving a request for generation of the preview information from a user; wherein the generating of the preview information is performed according to the user's request for generation of the preview information.

3. The method of claim 1, wherein, the receiving of the input element selection movement request for an input element selection movement comprises receiving a request for one of input elements that are the most adjacent to the currently selected input element in up, down, left, and right directions, respectively, from the currently selected input element as the input element selection movement request.

4. The method of claim 3, wherein the generating of the preview information comprises:
identifying an input element to be selected according to the input element selection movement request;
extracting information on a position and size of the identified input element; and
generating preview information displaying the identified input element using the extracted position and size information.

5. The method of claim 4, wherein:
the generating of preview information comprising generating a line connecting the currently selected input element and the identified input element as the preview information; and
the displaying of the preview information comprises displaying the generated line on the menu information.

6. A method of displaying input element selection information on menu information including at least one input element, the method comprising:
receiving a request to display access key display information on each input element included in a currently displayed menu information; and
displaying the access key display information on each input element corresponding to the request.

7. The method of claim 6, wherein the displaying of the access key display information on the input element comprises:
determining whether access key information for selection of each input element is assigned to each input element included in the currently displayed menu information;
generating the access key display information using the assigned access key information when the access key information is assigned to each input element; and
displaying the generated access key display information on each input element.

8. The method of claim 7, wherein the generating of the access key display information comprises:
obtaining information on a position and size of each input element to which the access key information is assigned; and
generating the access key display information based on the access key information assigned to each input element and the information on the position and size of each input element.

9. An apparatus to display input element selection information on menu information including at least one input element, the apparatus comprising:
a user interface to receive an input element selection movement request to move from a currently selected input element to another input element;
a preview information generation unit to generate preview information indicating which input element is to be selected according to the input element selection movement request through the user interface;
an output unit to display the generated preview information on the menu information; and
a controller to control the apparatus to generate the preview information according to the input element selection movement request through the user interface and to output the generated preview information.

10. The apparatus of claim 9, wherein:
the user interface receives a preview information generation request and transmits the received request to the controller; and
the controller controls the apparatus according to the preview information generation request to generate and output the preview information.

11. The apparatus of claim 9, wherein the user interface receives one of input elements that are the most adjacent to the currently selected input element in up, down, left, and right directions, respectively, from the currently selected input element, as the input element selection movement request.

12. The apparatus of claim 11, wherein:
the controller identifies an input element to be selected based on the input element selection movement request and informs the preview information generation unit of the identified input element; and
the preview information generation unit generates preview information indicating the identified input element based on the information on the position and size of the identified input element.

13. The apparatus of claim 12, wherein:
the preview information generation unit generates a line connecting the currently selected input element and the identified input element as the preview information; and
the output unit displays the generated line on the menu information.

14. The apparatus of claim 10, wherein the user interface is a plurality of user interfaces and includes a dedicated key for input of the preview information.

15. The apparatus of claim 10, wherein:
the user interface supports a two-step pressing function;
when the user interface is half pressed and the controller receives an input element selection movement request, the controller generates preview information; and
when the user interface is completely pressed and the input element selection movement is requested, the controller does not generate the preview information.

16. An apparatus to display input element selection information on menu information including at least one input element, the apparatus comprising:
a user interface to receive a request to display access key display information on each input element included in a currently displayed menu information;
an access key display information generation unit to generate the access key display information for each input element corresponding to the request;
an output unit to display the generated access key display information on each input element; and
a controller to control the apparatus to generate the access key display information according to the access key display information display request through the user interface and to output the generated access key display information.

17. The apparatus of claim 16, wherein, when the access key information for the selection of each input element is assigned to each input element included in the currently displayed menu information, the access key display information generation unit generates the access key display information based on the assigned access key information.

18. The apparatus of claim 17, wherein the access key display information generation unit obtains information on the position and size of each input element to which the access key information is assigned and generates the access key display information based on the access key information assigned to each input element and the information on the position and size of each input element.

19. The apparatus of claim 16, wherein the user interface is a dedicated key for receiving a request for display of the access key display information.

20. A computer readable recording medium storing a program to execute a method of claim 1 using one or more computers.

21. A computer readable recording medium storing a program to execute a method of claim 6 using one or more computers.

22. A method of displaying preview information in a user interface, the method comprising:
determining a currently selected user interface element; and
displaying preview information based on the currently selected user interface element, the preview information corresponding to a result of inputting each of a plurality of instructions via a user input device.

23. The method of claim 22, wherein the displaying of the preview information comprises:
displaying a plurality of access information on the user interface;
wherein each of the plurality of access information is displayed so as to overlap a corresponding one of a plurality of user interface elements displayed on the user interface; and
wherein each of the plurality of access information corresponds to a result of inputting a corresponding one of the plurality of instructions.

24. The method of claim 23, wherein each instruction corresponds to a button on the user interface device.

25. An apparatus to display input element selection information on a menu, the apparatus comprising:
a preview information generation unit to generate preview information indicating which of a plurality of input elements is to be selected according to an input element selection movement request received via a user interface;
an output unit to display the generated preview information on the menu; and
a controller to control the apparatus to generate the preview information based on the input element selected movement request and to output the generated preview information.

26. An apparatus to display input element selection information on a menu having at least one input element, the apparatus comprising:
an access key display generation unit to generate access key display information for each input element;
an output unit to display the generated access key display information so as to overlap a corresponding input element;
a controller to control the apparatus to generate the access key display information and to output the generated access key display information.
